(19) United States
(12) Patent Application Publication
(10) Pub. No.: US 2024/0185372 A1
(43) Pub. Date: Jun. 6, 2024

(54) SYSTEMS AND METHODS FOR FRAUD PREVENTION

(71) Applicant: REWIRE HOLDING LTD., London (GB)

(72) Inventors: Jose Luis Merino GONZALEZ, London (GB); Jesus Ruiz GONZALEZ, London (GB)

(21) Appl. No.: 18/554,134

(22) PCT Filed: Apr. 14, 2022
(86) PCT No.: PCT/GB2022/050950

§ 371 Date: Oct. 5, 2023

(30) Foreign Application Priority Data
Apr. 14, 2021 (GB) 2105307.9

(51) Int. Cl. G06Q 50/26; G06Q 20/40

(52) U.S. Cl. CPC G06Q 50/265; G06Q 20/40145; G06Q 20/4016

(57) ABSTRACT

A system and method of operating an anti-fraud, AML and ATF system using a “selfie” (photo of one self) or a face extracted from a photo to become the “selfie” as the key information to automate certain anti-fraud, anti-money laundering (AML) or anti-terrorist financing (ATF) aspects through the use of fixed or wireless devices or portable computers or desktop computers, with at least one build in camera and an application software in the device as per this invention, such devices adapted as per this invention, whereas the system server is adapted to include a local processing unit and/or a remote server processing unit adapted as per this invention. The “selfie” is converted as per this invention to replace the original, requiring less memory space and thus less processing-power or -time when comparing pairs of photos or selfies as per the methods and system of this invention.

### FIELD OF THE INVENTION

Systems and methods of operating an anti-fraud detection and management of user accounts where KYC (know your customer) or KYB (know your business) is optional, but a photo e.g. a “selfie” (photo of one self) is mandatory to automate certain anti-fraud, anti-money laundering (AML) or anti-terrorist financing (ATF) processing aspects through the use of fixed- or wireless-devices or portable- or desktop-computers, with at least one built in camera, such devices adapted as per examples of this invention and included in the system is a local- or remote processing unit or server to process the photos e.g. selfies as per the methods and/or flowcharts of examples of this invention. Aspects of the disclosures relate in particular to a system and method of enabling a Custom-Made-ANTI-FRAUD MODULE “CMAFM” to be part of an onboarding or account creation of payments-, insurance-, banking-, fintech-, exchange-, brokerage system or any such other system that requires the user to upload his identification document (s), specifically a photo of himself (selfie) as part of the information provided by the new user to create a new account or to perform certain transactions of an existing account where users authentication is crucial to ensure anti-fraud or AML or ATF processing.

Other aspects of disclosures include enabling those adapted fixed- or wireless-devices or portable- or desktop-computers, with at least one built-in camera, (AD) “Adapted Devices” as per examples of this invention to open for example a new banking account or to make a transaction deemed critical. The main objective of examples of this invention is identifying a potential fraud, AML or ATF in as many cases as possible before it happens but also to find such potential fraud, AML or ATF cases in past or existing databases of still active accounts to take appropriate corrective measures. In some cases, the measures can be as simple as blocking access to that account, but in other cases it can be blocking only outgoing transactions but allowing incoming transactions such that potential defrauded people can receive their monies back and the person committing such crime can be prosecuted once sufficient information evidence has been collected by legal means and provided to the appropriate authorities.

In examples of this invention, contrary to the prior art, the photo of the user, e.g. also known as “selfie”, preferably already when creating a new account or alternatively in addition to, when instructing a transaction deemed critical, is the key data used by examples of the innovative methods and systems. The photo e.g. selfie in examples of this invention is forced to be taken by the camera of the AD (Adapted Device) that has been adapted as per examples of this invention, and does not allow any external photos uploads, with the exception when verifying legacy databases with examples of this invention. Also, the photo e.g. selfie taken by the AD is the last one in a series of continuous consecutive photos (example: a series of 5 continuous consecutive photos) over a short time span (example: over around a second) and are compared with each other to ensure there is movement between them, meaning that the distance between certain waypoints is different, detecting for example eyes closing and opening or the face turning left or right or up or down compared to waypoints of the shoulder or neck or between other reference points of the face itself and so forth. This last point will avoid in most cases that users can take a photo of a photo, because in that case the distance between all waypoints are the same in all consecutive photos and thus would be considered a non-valid photo e.g. selfie and in that case the “CMAFM “Custom-Made-ANTI-FRAUD MODULE” would trigger an alert to take protective measures, that can be as simple as requesting a new photo e.g. selfie or if repeated then denying an account creation or if an account already exists and the user was performing a critical transaction then that transaction would be denied and measures will be taken, for example blocking all outgoing transactions.

Any photo e.g. selfie considered as potential risk (re anti-fraud, AML or ATF) is flagged by the CMAFM and is stored in a “blacklisted photos e.g. selfies database” (BSD) to use those as the first checkpoint of any new photo e.g. selfie of new accounts creations and of any transaction considered critical that requires also a photo e.g. selfie to confirm the transaction, to avoid as is the case in the prior art that a genuine user creates an account with his own real identification documents but then such user passes on his account credentials to another person who is the one that truly uses the account or makes the actual critical outgoing transactions, in which case examples of our invention will be comparing the photo e.g. selfie of the person taken with that device at the moment of wanting to do a transaction and compares it first with the BSD and only in the event of a new account creation, the photo e.g. selfie is then checked by comparing the photo e.g. selfie with the “full historical photos e.g. selfies database” to avoid that a same user opens more than one account, unless he is authorised up until the authorised limit, and is flagged after exceeding that limit (for example, limit one user account per individual, meaning in examples of our invention per photo e.g. selfie).

If, however during an account creation the photo e.g. selfie of the person coincides with one of the BSD of examples of this invention, then corrective and protective measures are taken as that photo e.g. selfie is flagged as a potential or confirmed fraud or AML or ATF but also for all other photos e.g. selfies with a match above the set percentage limit, as well as all accounts associated with those flagged photos e.g. selfies, in example the corresponding usernames and/or verified emails and/or verified phone numbers.

If, however during a transaction considered to be critical the photo e.g. selfie of the person coincides with one of the BSD of examples of this invention, corrective measures are taken as that is flagged as a potential or confirmed fraud or AML or ATF, and additionally if the photo e.g. selfie of the critical transaction is deemed to be different than the photo e.g. selfie of that account creation then the photo e.g. selfie of the account creation is also put in the BSD (blacklisted photos e.g. selfies database) of examples of this invention.

In this way the critical transactions execution of existing accounts or new accounts created is always between identified or authenticated system users' photos e.g. selfies (meaning never anonymous) yet protecting user's data privacy.

In one variant of an embodiment of an example of this invention, the photo(s) e.g. selfie(s) stored in databases is replaced by the digital representation of the photo e.g. selfie and not the actual photo e.g. selfie, meaning an encrypted form of the photo e.g. selfie or a matrix representation of the result of the photo e.g. selfie passing through a self-learning artificial intelligence logic. For example, where a matrix represents a pixel as a combination of colour, luminance etc., they are replaced by a combination of a number (0 to 9) and a letter (a to z potentially adding special letters like ñ, ç, ę, ü, ĩ, ö, ä would be 33 different letters and so forth), such combination of letters and number limited to a fixed amount n to distinguish a given pixel or a combination of a certain array of x-by-y pixels as a combination of a series of numbers and letters.

In the prior art, a process to create a biometrical ID from a photo begins with the photo being processed in a neural network, that is trained to settle all the recognition points, or also knows as a parameter, required to identify a face, be it from an identity document or a photo e.g. selfie (photo of one self). These points are stored, as known to the person skilled in the art, as a FLOAT32 format, by pairs, stored in a Biometric ID File (BIDF), describing the absolute position of every point related to the cartesian initial points of the photo. Due to the different photo sizes and resolutions, this precision is needed to reference every point (see e.g. FIG. 5). To compare two photos and check if the faces are the same, both are processed to get the BIDF of each photo, and distances are extracted to get the level of difference between the images. If the match result between a pair of BIDF is over or under the predefined level of accuracy, the result is defined as negative or positive match, respectively.

The shortcoming of the prior art is that this comparison method is strongly dependent of the position of the face or head in each photo. For example, if one of the photos shows a partially sided face and one ear is missing or one photo of the same person has glasses or a beard or shorter or longer hair and the other doesn't, the comparison method could produce negative match where in fact a positive match was expected.

Another shortcoming of the prior art is the need to store all the FLOAT32 pairs or similar ones in the BIDF with the same precision, but the results and distances are always taken as an order of magnitude, so we need to allocate more memory to store the BIDF in the prior art than what we would need with the method and system of examples of this invention.

The calculation of the minimum size of a given photo file, for n points, considering that one FLOAT32 var needs 4 bytes to be stored, is as follows:

Size1=n points*2 axis*4 bytes/point

For example, if we create a BIDF with 1,024 points, we will need 1,024 points*2 axis*4 bytes=8, 192 bytes for every BIDF, that will be read and processed every time we would need to compare a new photo (e.g. selfie) with all the previously stored photos (e.g. selfies) of examples of this invention, thus this needs an innovative solution to reduce the required storage space and consequently reduce the required processing power.

In a different embodiment of an example of the present invention, our system resolves the previous mentioned shortcomings as follows;
in a first step, settling an array of “n” points on the face area of a photo or selfie, and saving the relative position of one specific point, considered the Main Point of Comparison (MPOC) for this BIDF based on a cartesian system, also in FLOAT 32.
in a second step, the rest of the points are stored considering their relative position with the MPOC. For these points our system uses a char-based variable, which means that we can use a different base depending on the required accuracy.
in a third step, the formula used by an example of our invention to calculate the required space for a photo with n points is the following:

Size2=[1 point*4 bytes+(n−1)*(requiredbytes)]*2 axis

wherein requiredbytes=(number of symbols/256)*2 bytes Consider that we need to round up the result to integer values. For example, with a char-based variable with 256 symbols, we need only 2 bytes to store the relative position for every axis. For a BIDF with 1,024 points the calculated size with the 2 different methods would be as follows:

Prior-art-size1=1,024 points*2 axis*4 bytes/point=8,192 bytes

This-invention-size2=[1 point*4 bytes+(1,024−1)*(2 bytes)]*2 axis=[4 bytes+2,046 bytes]*2=4,100 bytes

In this example, we have a 49.95% reduction in the size of the BIDF, keeping the same precision for the points information reducing around by half the required memory space and consequently reducing the processing power and time required to process a positive or negative match between a pair of photos or selfies by the same proportionate amount.

In a different embodiment of an example of the present invention the photo e.g. selfie is stored as the relevant data to be used by examples of this invention, namely as the distance between reference points of the face and those are then translated into a magnitude (proportional) to a given pre-selected reference distance. For example, one of the references is taken as the “distance between the centre of the eyes” (D1) and any other distance is then stored as a magnitude more or less than that distance D1, for example the width of the nose as a lesser distance as for example “0.276540” times D1 or the distance between the left and right earlobes. Larger distances as for example “2.194562” times D1 and so forth, many more proportionate distances between all kind of different points of the face are taken always as a magnitude of the different reference distances.

Another reference distance could be “the width of the nose” as (D2) and take all the other measures as a magnitude of D2.

In fact any of the used distance between two points can be taken as the reference distance (Dn) and all the other distances are taken as a magnitude of Dn for each distance, in order to allow for changes in people's faces, such as when wearing glasses or with or without a beard, or any such other potential genuine variations such as a photo e.g. selfie being taken closer or further away from the face resulting in the face being bigger or smaller in different photos e.g. selfies of the same person, to still allow to match the photo e.g. selfie to a photo e.g. selfie in any of the available databases with a given acceptable percentage threshold of accuracy, which can be the same or different for different population segments or ethnicities.

### BACKGROUND OF THE INVENTION

Traditional account creation methods in existing systems are evolving from physical account creation methods to so called remote account creation through an app on a smartphone or through a portable or desktop computer with a built-in camera.

The pandemic that started in early 2020 accelerated this transformation of remote account opening and at the same time the potential and confirmed fraud and anti-money laundering ways used by people to conduct their unlawful activities has adapted accordingly.

The internet and regulation helped create the right framework for remote account opening and remote transactions from the comfort of one's home but so did it give access to fraudsters and people committing anti-money laundering or AML or ATF remotely too.

The most advanced methods for anti-fraud and anti-money laundering or anti-terrorist financing, have added in their systems many things to mitigate it, from verifying patterns in transactions or checking destination country or destination person's name against blacklists shared between & with multiple sources now adding a strong focus on stopping potential fraudsters that correlate more often than not, equating to money laundering as these people who commit fraud hardly were planning to pay any taxes on the amount de-frauded from other non-suspecting honest citizens.

In some cases, to stop unlawful transactions by w willing participants, for example wanting to finance terrorist activities or to provide their account credentials to organised gangs committing widespread fraud and, in some cases, making payment for those accounts access to poorer segments of the population it becomes extremely difficult with the prior art other than after the fact, when someone reports such potential cases to the authorities. Even blocking those accounts is just a drop in the ocean as they can use many genuine users' created accounts and get free or paid access to those accounts for their unlawful money collection means. A typical fraud example is to sell goods and services online under market price to unsuspecting buyers online and collect payment in to those current accounts they got access from willing participants giving their current account credentials to those criminal individuals or organised criminal gangs who never intended to ship any goods and let alone declare any such income to pay their due taxes as the use of funds is intended for illicit purposes. So, blocking just one account is no solution when they have access to many accounts of other users which the criminals operate. Examples of our invention resolve most of those cases. The prior art improved the recognition of tampered with identification documents, to detect any fraudulent identity documents and to extract the data from such identity documents as those have moved to standardized formats by most western governments (such as first names, surnames, birthdate, address, document type, document number, expiration date and so forth) and they even check if there is a resemblance between a photo e.g. selfie (photo of the user creating a new account) and the photo on the identity document and in some cases they check if there is a liveness of movement in the photo e.g. selfie and in some cases they go as far as checking liveness of movement by making a video of the user and asking by voice record or text on the screen giving the user instructions to move the face up, down or left right or even repeat or read a text as voice recognition.

Such methods and systems require a very high processing capability and a very high amount of storage space for all such information. The intellectual property rights by a certain small amount of industry players in the field also tend to lift the cost for medium to smaller entrants and remain thus exposed to fraud, AML and ATF. Whilst industry players (companies) with sufficient funds can afford to pay specialised third parties, it then becomes a matter of how many still slip through all those prior art checks as obtaining a zero fraud passthrough is almost impossible, and the bigger question is when is the friction too much of such anti-fraud measure that make users not complete the onboarding or are not willing to go through such exhaustive methods of a video with those instructions on what to say or where and how to more the head and so forth.

Despite the amazing improvements in digital photo recognition services and a wide variety of competing companies to choose performing KYC and/or KYB of individuals when opening an account or do a liveness check on critical transactions, there are still certain shortcomings that need to be improved or overcome.

Some of the shortcomings of the prior art are:
(i)—When a user or many users create an account with real ID documents and their photo e.g. selfie, but then give their credentials to an individual or to an organised gang or unlawful organisation with the intent to commit fraud or money laundering or terrorist financing, those cases are not detected by any of the current known KYC or KYB methods or systems.
(ii)—Since a photo on identification documents is of a much smaller size than a photo e.g. selfie, the accuracy of the similarity check of the photo e.g. selfie versus the photo of the identity document is limited by the accuracy of the small size of the ID photo of a face. In most cases, on an average smartphone screen-size, the face of an ID photo is roughly 1.5 cm by 2 cm on screen versus a photo e.g. selfie size on the screen is 4.5 cm by 8 cm or more. This means the accuracy of the ID face on that photo is at least 300% less accurate than the photo e.g. selfie so in the best of cases only a similarity can be looked for. So really the most accurate info from an ID document is really the extracted data from the governments standardized information on that document.
(iii)—as unlawful individuals or organized gangs become more familiar with remote KYC, KYB or sensitive transactions protective measures against fraudulent or unlawful use it becomes increasingly more difficult to identify such unlawful individuals. For example, criminals have been doing things like creating multiple accounts with different emails, different mobile phones, changing only one character barely visible to the eye or checking programs such as changing a first capital letter from “1”=spoken “el” to “I” spoken “eye” or change a letter “O” spoken “oh” to a number “0” spoken zero and so forth. Even opening multiple accounts with different documents of the same person, such as one account with a Driving License, another one with a national identity card, and yet another with a passport, for example.
(iv)—Another shortcoming is the potential fraud increase due to the fact that certain regulations make it difficult to share user information due to end-users' data protection regulations, which are more stricter in some countries or regions then others, making it more difficult to identify those potential fraudsters or even share the identity or information between companies of those confirmed fraud or AML or ATF cases between them, other than government sanction lists that can be used more widely which do not stop the shortcomings explained here in the prior art.
(v)—Yet another shortcoming of the prior art is that in all prior art, they check the new accounts creations versus past accounts info of those who were confirmed as past fraud, AML or ATF, comparing mainly against similarity of the combination of full name and birthday, identity document used in the past but as we know from the previous shortcomings that leaves the door still wide open to many ways from fraudsters or those with unlawful intent to exploit the current security measures at account creation or at critical transactions. Even using the smartphone's built-in face-ID as a two-factor identification, this can't detect the fact that those credentials were given by a willing participant in crime to a criminal or fraudster who then uses his face ID to make the login easier for him on all those accounts he got the credentials from, so rather than stopping crime some prior art in some cases even facilitates unlawful use of certain accounts by criminal with unlawful intent.
(vi) Finally, a different shortcoming is the fact that the prior art stores the actual photo e.g. selfie of users in a raw manner, be it in some cases simply compressed to a safe space but that is about the extent of it. This then requires a high level of processing power if the photos e.g. selfies were to be processed beyond what the prior art currently does, namely to compare the photo e.g. selfie with a much lower resolution face on the identity document, thus not really requiring much resolution on the photo e.g. selfie itself. This means that the photo e.g. selfie stored in a lower resolution becomes then inaccurate to be used for accurate verification processes beyond the account creation, where a similarity between the photo e.g. selfie and the face on the photo-ID is sufficient. That low resolution or discrepancy between the size of the face on the ID photo and the size of the photo e.g. selfie allows many fraudsters to cheat some of the current prior art. In some cases, we have found that sometimes a photo e.g. selfie of a completely different person, with very vague similarities seen by the human eye clearly as a different person to that of the photo of the identification documents is passed as being sufficiently similar, thus allowing criminals through. Once in, once an account is created the criminals are free to operate until someone reports them, which is a shame for all those he or she can still defraud with other accounts that he may have under his control.

Current systems need a massive amount of storage for those identity documents and photos e.g. selfies photos, meaning using those to process after account creation becomes truly expensive for companies who want to secure for example all their outgoing transactions, or the critical transactions or subscribe to a new service such as for example subscribe to an online loan or insurance and so forth.

Although traditional KYC methods are perfectly workable as a business as they were profitable businesses in their own right, the fact is that the external companies who do KYC/KYB do not explicitly look to prevent fraud or AML or ATF and leave that to the companies or businesses to deal with. Traditional methods of face-to-face accounts opening are slowly being phased out and the need to focus on anti-fraud, AML or ATF at the account opening stage and on critical transactions thereafter will become more and more important but those innovations have not yet caught up at the same innovation level as remote KYC only innovation did. Examples of our invention resolve the mentioned prior art shortcomings. Our findings confirm that there is a correlation between the same photo e.g. selfie used in different unauthorised accounts or in transactions of different accounts and correlates to one or more of the following: fraud, money laundering or terrorist financing. Examples of our invention resolve the prior art shortcomings.

Examples of this invention will verify on account creation if the photo e.g. selfie matches (i.e., >75% similarity) to any photo e.g. selfie in our database of past photos e.g. selfies flagged as potential or confirmed fraud, AML or ATF and then checks if that photo e.g. selfie matches with any other photo e.g. selfie of already existing accounts and if a match is found blocks such account creation. After account creation on transactions considered critical, or at random transactions, the user is requested for a real time photo e.g. selfie to be taken to confirm the transaction execution and if that photo e.g. selfie does not match the photo e.g. selfie of that account creation, then that account is blocked as well as all other accounts with the transaction photo e.g. selfie used during account creation. If a match is found, then all the matching photos e.g. selfies in the database will be used to do a secondary search for a match in the available databases and block those accounts with any matching photo e.g. selfie too. Thus, resolving all the prior art shortcomings listed herein.

In a different embodiment, an example of this invention will take the incoming photo(s) e.g. selfie(s) in the highest quality possible, such quality set as camera hardware setting depending on the available bandwidth, calculated prior to the time of requesting the user to confirm to take his photo e.g. selfie. Such high-quality photo e.g. selfie is then processed in parallel in two different ways by examples of this invention:
(a) a compression is performed to reduce the photo e.g. selfie size and store that very reduced file size, yet with sufficient quality for the human eye to recognise the person on the photo e.g. selfie (e.g. perfectly) for potential future prosecution evidence. Example: reduce from 10 Mb to 100Kb would mean a cloud storage space reduction of 100 to 1 in this example.
(b) a conversion is performed to the photo e.g. selfie where first a number “x” waypoints are identified on the face out of a total defined of “n” points. Each waypoint “x” to “x.n” is then taken starting as the distance from:
(a) “x” to “x1” and every other available distance “x” to “X2” . . . to “x” to “xn” is taken as a magnitude of the first distance “x to x1” that is considered the unit.
(b) “x1” to “x2” and every other available distance “x1” to “x”, and “x1” to “x3” . . . to “x1” to “xn” is taken as a magnitude of the first distance “x1 to x2” that is considered the unit.
(b) “x2” to “x3” and every other available distance “x3” to “x”, and “x3” to “x2”, and “x3” to “x4” . . . to “x3” to “xn” is taken as a magnitude of the first distance “x2 to x3” that is considered the unit.

And so forth . . .
(d) “xn−1” to “xn” and every other available distance “xn−1” to “x”, and “xn−1” to “x2”, . . . to “xn−1” to “xn−2” is taken as a magnitude of the first distance “xn−1 to xn” that is considered the unit.

These distances are then filtered and only the existing distance magnitudes are stored, as one matrix or as one list of magnitudes per unit distance, meaning in the above example “n” matrixes or “n” lists of magnitude, each versus their respective reference unit distance. Once these matrixes or list of magnitudes are stored as the digital representation of each photo e.g. selfie associated to an account or not associated to an account but instead to a photo e.g. selfie flagged as high risk to potential or confirmed fraud, AML or ATF and is stored as a forbidden photo e.g. selfie database. At this point the high-quality original photo e.g. selfie will be deleted from the system to reduce space and thus reduce processing time as the stored digital representation, as defined in examples of this invention, is what is used for photos e.g. selfies comparison in examples of this invention.

In a different embodiment of an example of our invention photos e.g. selfies are extracted from available public information of those confirmed sanctioned individuals by certain applicable governments backlist (s) and fed into examples of this invention in the forbidden photos e.g. selfies database.

In a different embodiment of an example of the present invention, the actual face recognition matching module in the system of examples of this invention may be a third party face recognition matching module that will provide trigger outputs in the form of a different flag if the match is similar (above a minimum but below a certain higher percentage) or if the match is identical (above the previous mentioned higher percentage level) and the remainder of the system remains as the novelty of examples of this invention, whereas the method of examples of this invention is unaffected as the innovative method of examples of this invention remains the same, regardless of whose face recognition matching module is used herein.

### BRIEF SUMMARY OF THE INVENTION

According to a first aspect of the invention, there is provided an anti-fraud, anti-money laundering (AML), anti-terrorist financing (ATF) system of claim 1.

According to a second aspect of the invention, there is provided a method for anti-fraud, anti-money laundering (AML), anti-terrorist financing (ATF) detection of claim 15.

The present invention is designed to solve real issues in people's lives, such as (i) improving the security of people's digital assets to protect them from fraudulent activities by other people's unlawful acts or scams, (ii) secure the accounts of users across the industry spectrum where users store electronic value items, such as electronic money (bank accounts), crypto currencies, insurance portfolio, shares/ETF and so forth portfolio, etc, (iii) improve the compliance with current regulations of AML and ATF, and at the same time reduce the financial and image exposure of potential fraud to users of a given system/platform or fraud by an account of a given system to a user of a different system/platform. The present invention is designed to overcome the shortcomings of the prior art and to provide an automated way of resolving the shortcomings of the prior art specifically in the prevention and detection of potential fraud, AML or ATF. Such method and system in one embodiment rely on access given by users to the camera hardware of the device or otherwise service is refused. In another embodiment rely on the photos e.g. selfies coming into the method or system of examples of this invention to have been entered manually, in example by the compliance team, or in other cases relies on third parties having taken the photo e.g. selfie in compliance with the requirements of examples of this invention (photo e.g. selfie having been taken by the device camera and not uploaded by the user or taken by the camera from a still image or other picture), or the third party having used the “application software” of examples of this invention in order to benefit from all the benefits of examples of this invention.

The devices herein are fixed- or wireless-devices, smartphones, tablets, portable- or desktop-computers and any such other different devices that have a built-in camera and can download the application software of examples of this invention or have it built-in by the manufacturer and are adapted to communicate with the cloud hardware and cloud application software of examples of this invention.

### BRIEF DESCRIPTION OF THE SEVERAL VIEWS OF THE DRAWINGS

FIG. 1 is a typical embodiment of an example of the present invention, represented as a diagram or flow-chart of an anti-fraud, AML, ATF method and system.

FIG. 2 represents a diagram of a typical embodiment of an example of the present invention, forming an anti-fraud, AML, ATF system accessed and used by multiple companies. FIG. 2 is similar to FIG. 1 but adding multiple different companies that make use of examples of the present invention.

FIG. 3 represents a diagram or flow-chart of a typical embodiment of the prior art, forming an anti-fraud, AML, ATF system accessed and used by a single or multiple company.

FIG. 4 represents a diagram or flow-chart of a typical embodiment of an example of the present invention, wherein the prior art of FIG. 3 is shown and where all the new added parts of the diagram or flow-chart are specific to the method and system of examples of this invention.

FIG. 5 represents two cartesian diagrams, where in the prior art the points are referred as the distance between the point and the origin. In examples of our system, the Main Point of Comparison (MPOC) is referred to as the origin, but the rest of the points are referred to as their position with respect to MPOC, and not to the origin, forming an array of two-dimensional positions for each different MPOC.

FIG. 6 represents two cartesian diagrams, where two examples of our system can be observed, considering each using a different point as the MPOC in every element of the array, and calculating the rest of the distances as a function of the selected MPOC, forming an array of distances for each different MPOC.

### DETAILED DESCRIPTION OF THE INVENTION

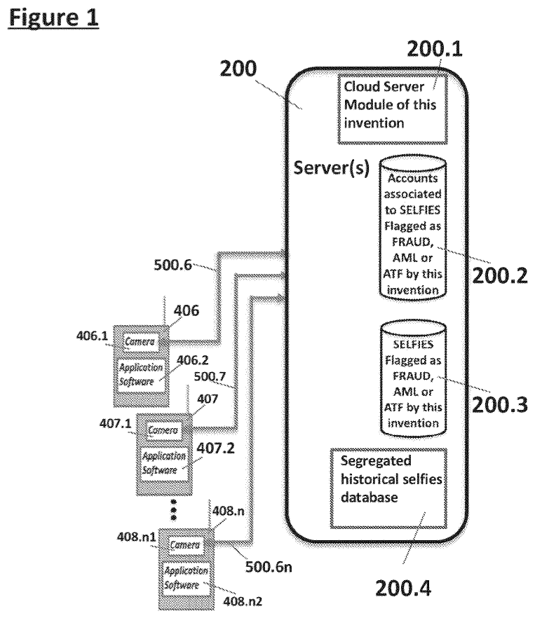

Specifically, FIG. 1 is a typical embodiment of an example of the present invention, represented as a diagram or flow-chart of an anti-fraud, AML, ATF method and system.

The devices 406, 407 to 408.n are wireless devices with a built-in camera and access to the internet, such as smartphones, tablets, portable computers (PCs), laptop computers and so forth. The devices are enabled to download an application software and execute it or enabled to execute a browser-based application software, where the application software controls certain parts of the hardware of the devices, such as the camera hardware (be it one or multiple cameras hardware available on a given device).

The application software sets the quality of the photo that is to be taken and draws a watermark on the screen leaving a clear oval space where the user has to put his face when he takes his photo e.g. “selfie” (e.g. user takes a photo of his complete face himself clicking on the take photo key) during an account creation or if he has an account as an authentication confirmation of his identity prior to the executing certain functions, such as for example to confirm an insurance application, to confirm an outgoing payment transfer, or any such other action considered to be sensitive.

In an example, the application software will only allow a photo e.g. selfie to be taken with the camera of the device that it controls and forbids any photos e.g. selfies or photos uploads from the devices taken at other times, so in fact only real time taken photo through the application software is allowed for security reasons.

The photo e.g. selfie is then sent to the server 200, where the “Cloud server module of an example of this invention” (200.1) processes the photo e.g. selfie into a format that it understands then first compares that photo e.g. selfie with the database called “photos e.g. SELFIES flagged as fraud, AML, or ATF by an example of this invention” (200.3) and any matches it extracts from the associated users accounts to the photos e.g. selfies matches and stores those in the database “Accounts associated to photos e.g. SELFIES flagged as FRAUD, AM, or ATF by an example of this invention” (200.2) and secondly after that the photo e.g. selfie will be compared against the photos e.g. selfies in the database called “Segregated historical photos e.g. selfies database” (200.4) and any matches it extracts from the associated users accounts to the photos e.g. selfies matches and stores those also in the database “Accounts associated to photos e.g. SELFIES flagged as FRAUD, AM, or ATF by an example of this invention” (200.2) and then at the end after all the previous steps, it stores the photo e.g. selfie itself in the “Segregated historical selfies database” (200.4) and then starts with the next incoming photo e.g. selfie. This process is done in parallel and when one parallel process is ended it waits for the next photo e.g. selfie to come in and starts again the same process.

In a different embodiment the database (200.3) of an example of this invention is fed by publicly found photos, extracting the face as the photo e.g. selfie, corresponding to certain or all individuals listed by government (s) sanctioned private individuals or foreign current or ex-politicians, listed typically by their names and birthdate on certain national and international sanctions lists.

In a different embodiment the database (200.3) of an example of this invention is fed by photos e.g. selfies from 3rd parties compliant to the applicable privacy regulation, extracting the face as the photo e.g. selfie, corresponding to certain or all individuals listed by those 3rd parties as confirmed or suspected of having committed previously at 3rd party's fraud, AML or ATF. When the match of the photo e.g. selfie with any other photos e.g. selfies in the databases 200.3 or 200.4 is above the minimum level but below the set level 1 (for example above the minimum >70% match but less than 75% (level 1)) then such photo e.g. selfie will not trigger any associated accounts to be automatically stored as flagged as fraud but rather a manual & visual check is required by a compliance person who decides if the match is acceptable to trigger a continuation of the process or an abort of the process for those photos e.g. selfies between those the minimum and level 1. However, if the photo e.g. selfie match is equal to or more than the level 1 match percentage (for example equal or >75%) then the (200.1) automatically decides and completes the process as described earlier and extracts and stores any account associated to any photos of selfies in the databases that match with the incoming photo e.g. selfie. There may be multiple servers (200) with each one or more of (200.1), and/or (200.2), and/or (200.3) and/or (200.4) included.

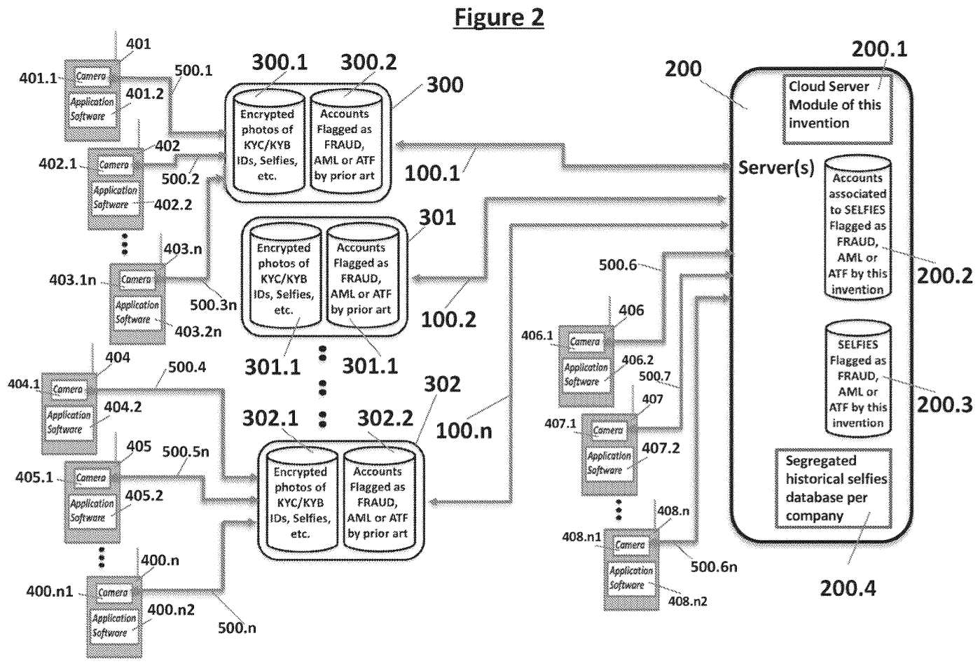

FIG. 2 represents a diagram of a typical embodiment of an example of the present invention, forming an anti-fraud, AML, ATF system accessed and used by multiple companies. FIG. 2 is similar to FIG. 1 but adding multiple different companies that make use of an example of the present invention which is (200) a server all companies that have authorisation from their users on their terms and conditions to store their photos e.g. selfies and the processed information or each have their own segregated server (200) if no user authorisation is obtained which each includes their own independent (200).1 and (200).2 and (200).3 and (200.4).

Company A would do one of two things: from the start use our Application Software module as a sub-module included in their own software module at the user device, or they may already have plenty users and need to clean-up a users account to make it more compliant and resistant to anti-fraud, AML, or ATF by passing each of the photos e.g. selfies in their database uploaded to the common database used by multiple companies or their own segregated (200) server database (200.3) and upload the accounts list associated to each photo e.g. selfie from which the accounts are identified of the matching photos e.g. selfies to store those in the database (200.2), as well as upload all the historical photos e.g. selfies in the database (200.4).

Devices (401), (402) to (403.n) are from users of a company that controls server (300) with included in their server at least two databases, those of with all the photos of relevant KYC (know your customer) and/or KYB (know your business) which include at least a photo of the user identity document and/or a photo of selfie that an example of this invention uses as the key information to identify anti-fraud, AML, ATF where each matching photo e.g. selfie is then linked by an example of our invention (200.1) to the same or different identity cards and/or linked to the same or multiple user accounts.

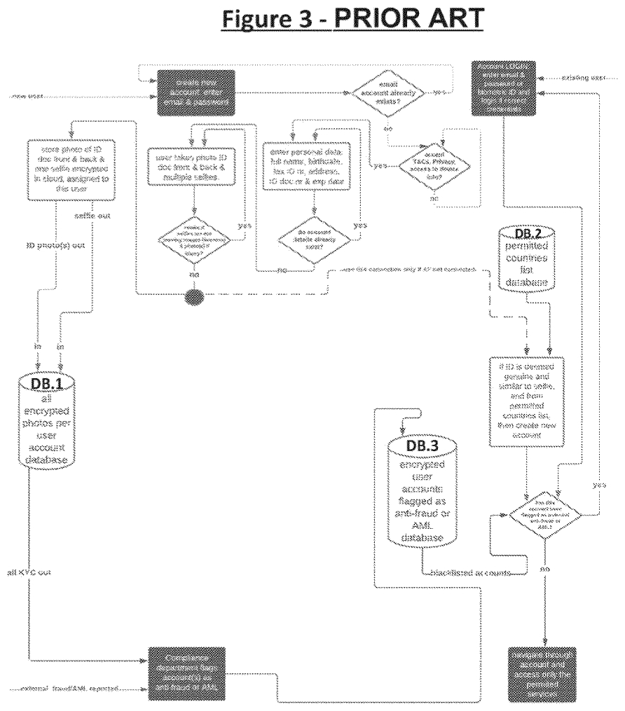

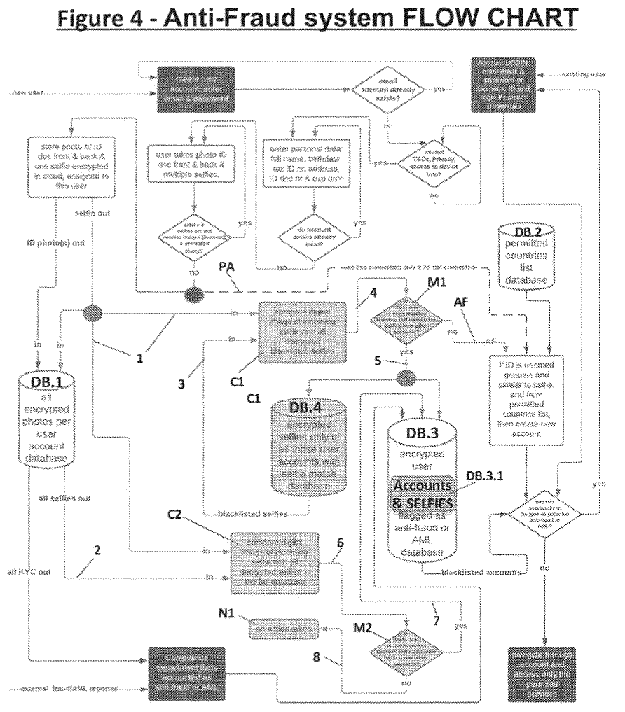

The company that controls server (301) with included in their server at least two databases, those of with all the photos of relevant KYC (know your customer) and/or KYB (know your business) which include at least a photo of the user identity document and/or a photo, e.g. selfie, that an example of this invention uses as the key information to identify anti-fraud, AML, ATF. Users of server 301 may have no direct access to that server, but rather server (301) is used as a mirror image of another server where the users do use the application software, such that server 301 is strictly and only used to perform the methods of photo e.g. selfie checks as per the flowchart (s) explained herein in FIG. 3 as per the prior art or as in FIG. 4 as per an example of this invention. Devices (404), (405) to (400.n) are from users of yet another company that controls server (302) with included in their server at least two databases, those of with all the photos e.g. selfie photos of relevant KYC (know your customer) and/or KYB (know your business) with the corresponding user account identification that matches each photo e.g. selfie to each user account and/or to each identity document and/or to each user verified email address and/or to each user verified mobile number. Those photos e.g. selfies are the ones an example of this invention uses as the key information to identify anti-fraud, AML, ATF where each matching photo e.g. selfie is then linked by an example of our invention (200.1) to the same or different identity cards and/or linked to the same or multiple user accounts and/or linked to the same or multiple user email addresses and/or linked to the same or multiple user mobile phone numbers and/or linked to the same or multiple user full names and birth dates.

FIG. 3 represents a diagram or flow-chart of a typical embodiment of the prior art, forming an anti-fraud, AML, ATF system accessed and used by a single company or multiple companies. In the prior art, the compliance department is the one that decides which user accounts are flagged as potential or definite fraud, AML or ATF and the main inputs to compliance tend to be the KYC and/or KYB information collected from the user or company wishing to use their services, or from external sources such as but not limited to comparing names and birthdates similarity to external privately shared or governments shared lists of individuals names and birthdates which are blacklisted for potential fraud, AML, ATF, or as part of a government sanctions or retaliation list which companies have to comply with and ban from using their services.

FIG. 4 represents a diagram or flow-chart of a typical embodiment of an example of the present invention, which includes the prior art of FIG. 3 shown as is and where all the new added parts of the diagram or flow-chart are specific to the method and system of an example of this invention. The new parts of an example of this invention are removing connection (PA) of the prior art and connecting instead (AF), adding two photos e.g. selfies matching checks (C1) and (C2) to check if a match is found, the respective decision being taken by (M1) and (M2), adding an additional newly created database (DB.4) where all those photos e.g. selfies which had a positive match within the set percentage limits are stored, and wherein the prior art database DB. 3 is adapted by adding to the list of accounts that are not to be allowed to operate, by adding inside the sub-database (DB. 3.1) where are the additional accounts that are stored that correspond to each of the photos e.g. selfies of (DB.4). Function (N1) is a function where no action is taken on the corresponding output of (M2) when no photo e.g. selfie match is found from the inputs of (C2).

In a different embodiment of an example of the present invention (DB.3.1) backlisted accounts list, includes the user accounts that correspond to the photos e.g. selfies of DB.4 and the photo e.g. selfie of (M1), wherein the user account is identified, by the valid login credentials and/or the account associated validated emails address, and/or the account associated validated mobile phone number, and/or the account associated ID document extracted full names and surnames & birthdate.

Many modifications and variations or different embodiments of examples of this present invention are possible in view of the disclosures herein, including this text, figures, drawings, flow-charts and explanations. It is to be understood that, within the scope of the appended claims, the inventions can be practiced other than as specifically described in the claims of the inventions and new claims can be extracted as new claims or as a divisional patent. The inventions which are intended to be protected should not, however, be construed as limited to the particular forms disclosed in the claims, or implementation examples outlined, as these are to be regarded as illustrative rather than restrictive. Variations and changes could be made by those skilled in the art without deviating from the novelty of the inventions. Accordingly, the detailed descriptions and figures of the inventions should be considered exemplary in nature and not limited to the novelties of the inventions as set forth in the claims.

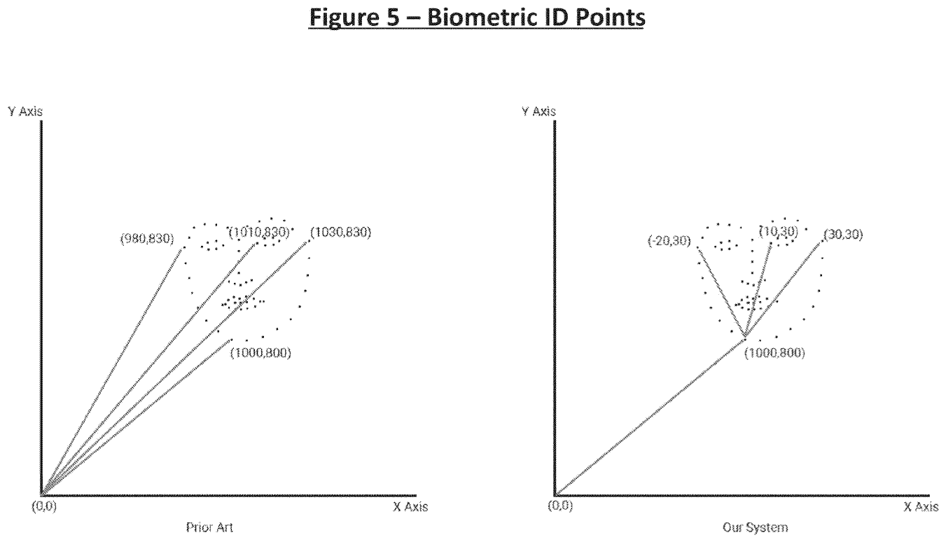

FIG. 5 represents two cartesian diagrams, where in the prior art the points are referred to as the distance between the point and the origin. In an example of our system, the Main Point of Comparison (MPOC) is referred to as the origin, but the rest of the points are referred to as their position with respect to MPOC, and not to the origin, forming an array of two-dimensional positions for each different MPOC.

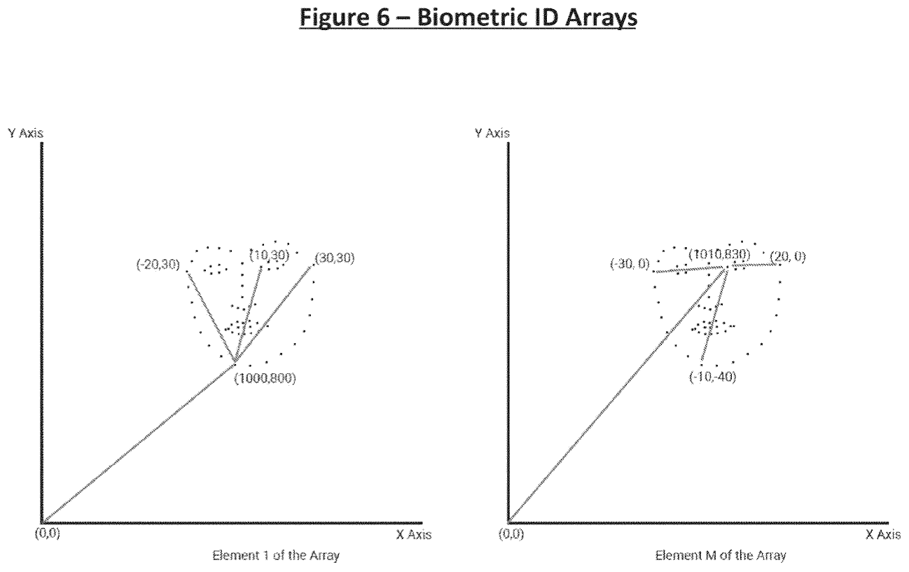

FIG. 6 represents two cartesian diagrams, where two examples of our system can be observed, considering each using a different point as the MPOC in every element of the array, and calculating the rest of the distances in function of the selected MPOC, forming an array of distances for each different MPOC.

There is provided systems and methods of operating an anti-fraud, AML and ATF system using a photo e.g. “selfie” (photo of one self) or a face extracted from a photo to become the “selfie” as the key information to automate certain anti-fraud, anti-money laundering (AML) or anti-terrorist financing (ATF) aspects through the use of fixed or wireless devices or portable computers or desktop computers, with at least one built-in camera and an application software in the device as per examples of this invention, such devices adapted as per examples of this invention, wherein the system server is adapted to include a local processing unit and/or a remote server processing unit adapted as per examples of this invention. The photo e.g. “selfie” is converted as per examples of this invention to replace the original, requiring less memory space and thus less processing-power or -time when comparing pairs of photos or selfies as per the methods and systems of examples of this invention.

1. An anti-fraud, anti-money laundering (AML), anti-terrorist financing (ATF) system, comprising of:
devices (D1, D2 to Dn) each including a built-in camera including camera hardware, and each configured for internet access, each adapted with a downloadable custom device application software to access the camera hardware and system servers through the internet, and
the system servers (SR1, SR2 to SRn), adapted with a downloadable custom server application software to allow authorised external access to the system servers through the internet and respond to those external authorised access requests, for example by the devices which are authenticated devices each with the custom device application software, and wherein
the system servers further comprise a fraud photos e.g. selfies (photo of users' faces) database (FSDB), including all the photo(s) e.g. selfie(s) identified as fraud, AML or ATF (F-AML-ATF-Selfies), and an accounts info database (AIDB), with the user accounts identification information associated with each historical photo(s) e.g. selfie(s) that was input to the system and was identified as a F-AML-ATF-Selfie, and
the system servers are adapted to access a remote historical photos e.g. selfies database (HSDB) of photos e.g. selfies sent by any of the devices to the HSDB, and
the system servers are adapted to access a remote digital comparison-modules (DCM1, DCM2 to DCMn) to compare two photos e.g. selfies (e.g. an incoming photo e.g. selfie with any photo e.g. selfie of any database accessible by the system servers), and wherein
each new photo e.g. selfie that is sent by any of the devices (D1, D2 to Dn) to any of the system servers (SR1, SR2 to SRn), meaning an incoming photo e.g. selfie (INS) to the system, is compared separately in parallel by DCM1 and DCM2 one by one with all photos e.g. selfies in the FSDB, and one by one with all the photos e.g. selfies in the HSDB, and wherein
in the event of any INS as an input to DCM1 matches with any photo e.g. selfie of the HSDB as the other input to DCM1, then the corresponding account(s) is/are flagged as an F-AML-ATF-Account in the database (AIDB), and a trigger is provided to authorised entities outside of the system as an anti-fraud (AF) indication such that when the AF is no then no match was found, and when the AF is yes then a positive match was found, and if no match was found then no action is taken and the system starts a new check when the next incoming photo e.g. selfie is received, and if a match was found then a trigger is provided by the system to authorised entities inside or outside of the system as a blacklisted accounts list (BLAL) indication with all identified blacklisted accounts associated with that incoming photo e.g. selfie, wherein
in the event of any INS as an input to DCM2 matches with any photo e.g. selfie of the FSDB as the other input to DCM2, then the corresponding account(s) is/are flagged as a F-AML-ATF-Accounts in the database (AIDB), and the incoming photo e.g. selfie that was flagged as a F-AML-ATF-Selfie is stored in the FSDB and the system starts a new check when the next incoming photo e.g. selfie is received, and if no match was found then a trigger is provided by the system to authorised entities inside or outside of the system as a no-anti-fraud (NO-AF) indication for that incoming photo e.g. selfie.

2. The system of claim 1 wherein the historical photos e.g. selfies database (HSDB) is part of the system server.

3. The system of claim 1 wherein the digital comparison-modules (DCM1, DCM2 to DCMn) are part of the system server.

4. The system of claim 1 wherein each photo e.g. selfie of the HSDB that matched with any flagged F-AML-ATF-Selfie is subsequently used as an individual INS to the system server.

5. The system of claim 1 wherein the parameters of each digital comparison-modules (DCM1, DCM2 to DCMn) are remotely settable in the system server as an X percentage and a Y percentage, wherein
a match as an F-AML-ATF-Selfie is confirmed by any individual DCM1, DCM2 to DCMn when both input photos e.g. selfies are considered identical, meaning when the digital result from both DCM inputs is equal to or more than the X percentage, and wherein
a visual check match is flagged as a potential unconfirmed F-AML-ATF-Selfie to be considered by a person with authorized access to the input pair photos e.g. selfies of the DCM1, DCM2 to DCMn, when the digital result from both DCM inputs is lower than the X percentage but higher than the Y percentage.

6. The system of claim 1 wherein in the event of the INS originating from a new user account opening is flagged as an F-AML-ATF-Selfie, by DCM1, then the next account login from that user is blocked.

7. The system of claim 1 wherein in the event of the INS originating from a new user account opening is flagged as an F-AML-ATF-Selfie, by DCM1, then from the next account login onwards all account outgoing transactions or transactions considered critical or reducing the assets amount or assets value are blocked for all user accounts in the AIDB associated to that F-AML-ATF-Selfie.

8. The system of claim 1 wherein in the event of the INS originating from a new user account opening is flagged as an F-AML-ATF-Selfie, by DCM2, then the account opening for that user is blocked.

9. The system of claim 1 wherein the system server is adapted to require an account user to take a photo e.g. selfie with the custom device application software and the device sends it to the system server as an INS as a confirmation to some or all outgoing transactions or transactions considered critical or reducing the assets amount or assets value and such transactions is only executed if the system server does not flag that INS as a F-AML-ATF-Selfie nor as a potential unconfirmed F-AML-ATF-Selfie.

10. The system of claim 1 wherein, the custom device application software of any device D1, D2 to Dn automatically checks the available internet bandwidth now (BWN) and adapts the device camera hardware to use the highest possible photo e.g. selfie quality, such that the upload of the photo e.g. selfie to the system server over the internet would be done in under X time, in example X=10 seconds, then for example if BWN is 10 Mb/sec then the highest camera hardware quality photo file size is set to be equal or lower then 100 Mb, and if BWN is for example 0.5 Mb/s then the highest camera hardware quality photo file size is set to be equal or lower then 5 Mb, wherein that selfie is then transferred by the custom device application software corresponding device D1, D2 to Dn to the corresponding system server SR1, SR2 to SRn as the INS.

11. The system of claim 1 wherein the system server is adapted to perform a file compression on each INS and stores those compressed INS (CINS) in a system server database, wherein the compression is reduced to file size of a CINS lower then 500Kb, and once the system completes the check cycle of that INS, then the system server deletes the INS and only keeps the CINS stored in the system server compressed historical selfies database (CHSDB).

12. The system of claim 1 wherein the system server is adapted to allow external remote authorised and authenticated access to upload F-AML-ATF-Selfies directly into the FSDB, wherein the AML-ATF-Selfies are from legally allowed sources, such as for example from a third party authorised to share such AML-ATF-Selfies or extracted from publicly available press photos from people listed by governments as blacklisted individuals.

13. The system, of claim 1, wherein the system server is adapted to perform a file conversion on each incoming photo e.g. selfie (INS) where first a number “x” of waypoints are identified on the photo e.g. selfie face, out of a total defined of “n” points, and wherein each distance between waypoint “x” to “x.n” is then used as the starting point as the distance between each combination of any other two waypoints as follows;
“x” to “x1” is taken as the unit distance of one (UD1) and every other available distance “x” to “x2”, “x” to “x3” . . . to “x” to “xn” are all stored relative to the magnitude of the UD1, for example x to x2=0,500 when it is half of the distance of UD1 or x to x3=1.357 when it is 1.357 times UD1, and
“xn−1” to “xn” is taken as the unit distance of one (UDn) and every other available distance “xn−1” to “x”, “xn−1” to “x1” . . . to “xn−1” to “xn” are all taken as a magnitude of the UDn, for example xn−1 to x=0,250 when a quarter of the distance of UDn or xn−1 to x1=1.492 when it is 1.492 times UDn, and wherein the system server stores all the possible combinations of the INS waypoints distances as the conversion-INS (CINS) and uses the CINS instead of the INS, e.g. the INS in claim 1.

14. The system, of claim 1, wherein the system server is adapted to perform a file conversion on each INS where first a number “n” of waypoints are identified on the photo e.g. selfie face, and wherein each distance between waypoint “x” to “x.n” is then used to convert the INS file into an array of bytes; wherein
in a first step, settling an array of “n” points on the face area of a photo e.g. selfie, and saving the relative position of one specific point, considered the Main Point of Comparison (MPOC) for this Biometric ID File (BIDF) based on a cartesian system, in FLOAT 32, and
in a second step, the rest of the points are stored considering their relative position with the MPOC using a char-based variable, which means that we can use a different base depending on the required accuracy set by the system server, and
in a third step, the following formula is used to calculate the required space for an INS with n points as follows:
Converted-INS-file-Size=[1 point*4 bytes+(n−1)*(requiredbytes)]*2 axis wherein requiredbytes=(number of symbols/256)*2 bytes.

15. A method for anti-fraud, anti-money laundering (AML), anti-terrorist financing (ATF) detection, comprising the steps of:
a—a device (D1) with a built-in camera and configured for internet access, adapted with a downloadable custom device application software, receiving an instruction (e.g. from an authenticated user) to take a photo e.g. selfie (photo of his face), the device taking the photo, and the custom device application software then transfers the photo to the system server (SR1), and
b—the system server (SR1) adapted with a downloadable custom server application software, and adapted to access a remote historical-selfies-database (HSDB), and adapted to access a remote digital comparison-modules (DCM1 and DCM2), receives the incoming photo e.g. selfie (INS) from D1, and
c—the system server inputs the INS as the first input to each of DCM1 and DCM2, and inputs each photo e.g. selfie one by one as the second input of DCM1 from all photos e.g. selfies in the HSDB, and inputs each photo e.g. selfie one by one from all the fraud-selfies-database (FSDB) as the second input of DCM2, and
d—if a match is detected by DCM1 then an alarm is triggered by the system server and all the accounts associated with the INS are flagged as a fraudulent account, and
e—if a match is detected by DCM2 then an alarm is triggered by the system server and all the photos e.g. selfies of the HSDB associated with the INS are flagged as a fraudulent photo e.g. selfie and stored in the FSDB.

16. The method of claim 15, wherein
step “d-” generates a notification each time the DCM1 detects a match and provides the info of the accounts, associated with the photo pair e.g. selfie pair that DCM1 matched, to an external source for further processing of such information, and wherein
step “e-” generates a notification each time the DCM2 detects a match and provides the info of the photo pair e.g. selfie pair, associated with the DCM1 input that matched, to an external source for further processing of such information or as evidence for the authorities.

17. The method for anti-fraud, anti-money laundering (AML), anti-terrorist financing (ATF) detection of claim 15, comprising the steps;
(a)—an incoming photo e.g. selfie (INS) is populated with “x” waypoints on the photo e.g. selfie face, out of a total defined of “n” points, and
(b)—wherein each distance between waypoint “x” to “x.n” is then used as the starting point as the unity distance for each of the “n” array wherein each combination of any other two waypoints is extracted and stored following the next steps;
(c)—“x” to “x1” is taken as the unit distance of one (UD1) and every other available distance “x” to “x2”, “x” to “x3” . . . to “x” to “xn” are all stored as a magnitude of the UD1, for example x to x2=0,500 when half of the distance of UD1 or x to x3=1.357 when it is 1.357 times UD1, and
(d)—“xn−1” to “xn” is taken as the unit distance of one (UDn) and every other available distance “xn−1” to “x”, “xn−1” to “x1” . . . to “xn−1” to “xn” are all taken as a magnitude of the UDn, for example xn−1 to x=0,250 when a quarter of the distance of UDn or xn−1 to x1=1.492 when it is 1.492 times UDn, and wherein
(e)—all the possible available combinations of the INS waypoints distances are stored as the converted-INS (CINS) file representing the biometric face identification of the INS.

18. The method for anti-fraud, anti-money laundering (AML), anti-terrorist financing (ATF) detection of claim 15, comprising the steps:
(a)—in a first step, settling an array of “n” points on the face area of an incoming photo e.g. incoming selfie (INS), and saving the relative position of one specific point, considered the Main Point of Comparison (MPOC) for this BIDF based on a cartesian system, in FLOAT 32, and
in a second step, the rest of the points are stored considering their relative position with the MPOC using a char-based variable, which means that we can use a different base depending of the required accuracy set by the system server, and
in a third step, the following formula is used to calculate the required space for an INS with n points as follows:
Converted-INS-file-Size=[1 point*4 bytes+(n−1)*(requiredbytes)]*2 axis
wherein requiredbytes=(number of symbols/256)*2 bytes;
in a fourth step, the resulting arrays of bytes are then stored as the converted-INS (CINS) file representing the biometric face identification of the INS.

19. The system of claim 5, wherein the system server is adapted to require an account user to take a photo e.g. selfie with the custom device application software and the device sends it to the system server as an INS as a confirmation to some or all outgoing transactions or transactions considered critical or reducing the assets amount or assets value and such transactions is only executed if the system server does not flag that INS as a F-AML-ATF-Selfie nor as a potential unconfirmed F-AML-ATF-Selfie.

20. A method for anti-fraud, anti-money laundering (AML), anti-terrorist financing (ATF) detection, comprising the steps:
(a)—an incoming photo e.g. selfie (INS) is populated with “x” waypoints on the photo e.g. selfie face, out of a total defined of “n” points, and
(b)—wherein each distance between waypoint “x” to “x.n” is then used as the starting point as the unity distance for each of the “n” array wherein each combination of any other two waypoints is extracted and stored following the next steps;
(c)—“x” to “x1” is taken as the unit distance of one (UD1) and every other available distance “x” to “x2”, “x” to “x3” . . . to “x” to “xn” are all stored as a magnitude of the UD1, for example x to x2=0,500 when half of the distance of UD1 or x to x3=1.357 when it is 1.357 times UD1, and
(d)—“xn−1” to “xn” is taken as the unit distance of one (UDn) and every other available distance “xn−1” to “x”, “xn−1” to “x1” . . . to “xn−1” to “xn” are all taken as a magnitude of the UDn, for example xn−1 to x=0,250 when a quarter of the distance of UDn or xn−1 to x1=1.492 when it is 1.492 times UDn, and wherein
(e)—all the possible available combinations of the INS waypoints distances are stored as the converted-INS (CINS) file representing the biometric face identification of the INS.
